(19) United States
(12) Patent Application Publication
(10) Pub. No.: US 2015/0213255 A1
(43) Pub. Date: Jul. 30, 2015

(54) AUTHENTICATION SYSTEM

(71) Applicant: HEWLETT PACKARD DEVELOPMENT COMPANY, L.P., Houston, TX (US)

(72) Inventors: Jeffrey A. Lev, Tomball, TX (US); Monji G. Jabori, Houston, TX (US); Wei Ze Liu, Spring, TX (US); James R. Waldron, Houston, TX (US)

(21) Appl. No.: 14/419,689

(22) PCT Filed: Sep. 24, 2012
(86) PCT No.: PCT/US2012/056830

§ 371 Date: Feb. 5, 2015

(51) Int. Cl. G06F 21/44; G06F 21/45

(52) U.S. Cl. CPC G06F 21/44; G06F 21/45

(57) ABSTRACT

An authentication system is disclosed herein. An example includes a computing device and a port associated with the computing device for connection of an accessory to the computing device. The example also includes an authentication device that generates an accessory response upon receipt of a challenge and a hardware controller. The hardware controller generates both the challenge and an expected response to the challenge. It compares the expected response to the accessory response to ascertain if the accessory response is one of a valid response and an invalid response, and it signals for the port to be enabled for the valid response to allow access to functionality of the accessory by the computing device. Other features and components of the authentication system are also disclosed herein, as is a method of authenticating an accessory for use by a computing device.

### BACKGROUND

Consumers appreciate the ability to expand the features, performance, and capability of their computing devices. They also want to maintain the security and reliability of their computing devices. Businesses may, therefore, endeavor to provide such technology to these consumers.

### BRIEF DESCRIPTION OF THE DRAWINGS

The following detailed description references the drawings, wherein:

FIG. 1 is an example of an authentication system.

FIG. 2 is another example of an authentication system.

FIG. 3 is an additional example of an authentication system.

FIG. 4 is an example of a method of authenticating an accessory for use by a computing device.

FIG. 5 is an example of one or more further possible elements of the method of authenticating an accessory of FIG. 4.

### DETAILED DESCRIPTION

Computing devices often include the ability to utilize a variety of accessories. These accessories are designed to enhance the features, performance and capability of such computing devices by allowing them to access functionality resident on such accessories. This may be accomplished by connecting an accessory to a port associated with the computing device.

Unfortunately, miscreants of all sorts and kinds abound who may try to harm users of such computing devices by placing malicious material on such accessories that is designed to attack or otherwise “hack” their computing devices. Such attack or “hacking” can be of a variety of forms such as malware, spyware, viruses, spam, or other material designed to partially or completely disable a computing device and/or compromise the security of such a device or that of its user.

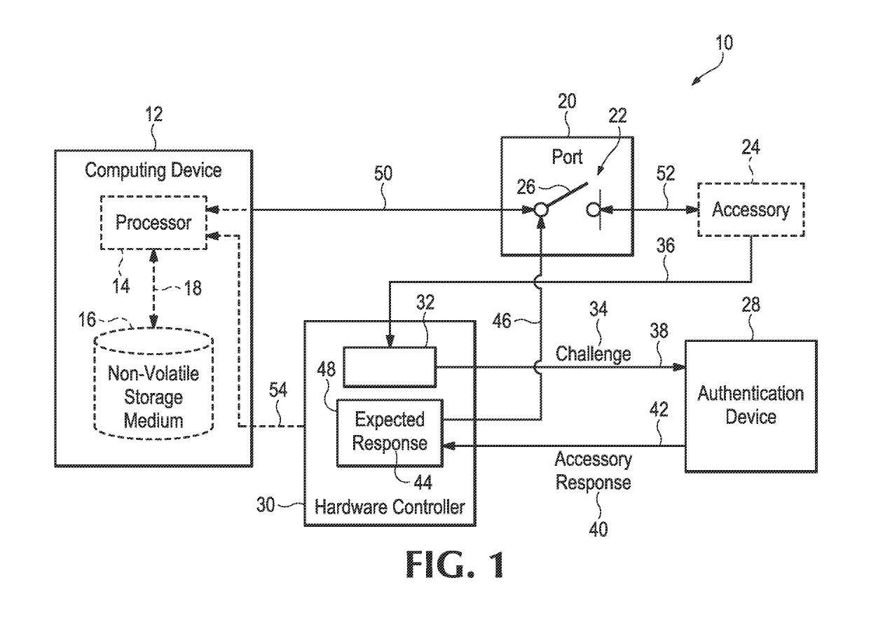

One way to help thwart the efforts of such nefarious individuals is to verify the integrity and source of an accessory before it is accessed or otherwise used by a computing device. An example of an authentication system 10 directed to achieving this objective is illustrated in FIG. 1.

As used herein, “accessory” is defined as including, but not necessarily being limited to, a device, component, peripheral, or apparatus that includes functionality that may be accessed, used with, or used by a computing device. Examples of accessories include, but are not limited to, memory cards, hard drives, “thumb drives”, cameras, audio components, printers, scanners, fax machines, copiers, etc.

As used herein, “port” is defined as including, but not necessarily being limited to, an interface between a computing device and an accessory. This interface includes a physical coupling or connection, an electrical coupling or connection, a magnetic coupling or connection, a transfer of one or more signals, and/or a transfer of power. A computing device may have more than one port and these ports may have the same or different interfaces. Additionally, the interface can be wired, wireless, or a combination of the two. Examples include, but are not limited to, Universal Serial Bus (USB), Serial Connect Serial Interface (SCSI), Ethernet, Firewire, Video Graphics Adapter (VGA), I²C, IEEE 1394, Direct Current (DC) power, etc. As noted above, a computing device may have more than one port and these ports may have the same (e.g., two USB ports) or different (e.g., one USB port and one SCSI port or two USB ports and one DC power port) interfaces.

As used herein, “challenge”, “expected response”, and “accessory response”, are defined as including, but not necessarily being limited to, messages, data, or information transmitted or communicated to authenticate an accessory for access to functionality thereof by a computing device. They may be encrypted, unencrypted, or partially encrypted. They may also be a predetermined or random number of bits or bytes. As used herein, “hardware controller” is defined, in part, as including a physical device that interfaces with an accessory and a processor of a computing device.

As used herein, “firmware” is defined as including a combination of persistent secure storage and instructions, functions, procedures, libraries, modules, and/or data thereon that help to control operation of a device. Firmware is permanent and not easily changed, reverse-engineered, or “hacked”, thereby providing security and protection against introduction of malware, viruses, spyware, unintended operational characteristics, or other malicious items onto a computing device or hardware controller.

As used herein, “software” is defined as including a collection of instructions, functions, procedures, libraries, modules, and or data that help to control operation of a device. Software is usually relatively easy to decompile and reverse engineer, allow it to be “hacked”, thereby allowing introduction of malware, viruses, spyware, unintended operational characteristics, or other malicious items onto a computing device.

As used herein, the term “processor” is defined as including, but not necessarily being limited to, an instruction execution system such as a computer/processor based system, an Application Specific Integrated Circuit (ASIC), or a hardware and/or software system that can fetch or obtain the logic from a non-transitory storage medium and execute the instructions contained therein. “Processor” can also include any state-machine, microprocessor, cloud-based utility, service or feature, or any other analogue, digital and/or mechanical implementation thereof.

As used herein, the term “non-transitory storage medium” is defined as including, but not necessarily being limited to, any media that can contain, store, or maintain programs, information, and data. A non-transitory storage medium may include any one of many physical media such as, for example, electronic, magnetic, optical, electromagnetic, or semiconductor media. More specific examples of suitable non-transitory storage medium and non-transitory computer-readable storage medium include, but are not limited to, a magnetic computer diskette such as floppy diskettes or hard drives, magnetic tape, a backed-up random access memory (RAM), a read-only memory (ROM), an erasable programmable read-only memory (EPROM), a flash drive, a compact disc (CD), or a digital video disk (DVD).

As used herein, “computing device” is defined as including, but not necessarily being limited to, a computer, server, phone, tablet, personal digital assistant, peripheral, document repository, storage array, or other similar item. A computing device may be “stand-alone”, independent, dependent, or networked. Additionally, a computing device may run or control one or more services (as a host) to serve the needs of users of other devices on a network. Examples include, but are not limited to, a database server, file server, mail server, print server, web server, gaming server, etc.

As used herein, the term “networked” and “network” are defined as including, but not necessarily being limited to, a collection of hardware (e.g., bridges, switches, routers, firewalls, etc.) and software (e.g., protocols, encryption, etc.) components interconnected by communication channels (intranet, internet, cloud, etc.) that allow sharing of resources and information. The communication channels may be wired (e.g., coax, fiber optic, etc.) and/or wireless (e.g., 802.11, Bluetooth, etc.), use various protocols (e.g., TCP/IP. Ethernet, etc.), have different topologies (ring, bus, mesh, etc.), and be localized (e.g., LAN) or distributed (e.g., WAN).

Referring again to FIG. 1, authentication system 10 includes a computing device 12 that may include a processor 14 and a non-volatile storage medium 16 that includes instructions executable by processor 14, as generally indicated by dashed double-headed arrow 18. Processor 14 may also store data on non-volatile storage medium 16, as also generally indicated by dashed doubled-headed arrow 18. Although not shown in FIG. 1, it is to be understood that computing device 12 may include other components and elements such as a keyboard, display, video card, etc.

As can also be seen in FIG. 1, authentication system 10 also includes a port 20 associated with computing device 12 for connection or coupling 22 of an accessory 24 to computing device 12. This coupling or connection 22 may be established in any of variety of ways depending upon the particular characteristics of port 20 and/or accessory 24. For sake of discussion purposes, it is illustrated as a switch 26 that is normally open prior to any verification of the integrity and source of accessory 24 by authentication system 10, as discussed more fully below.

As can additionally be seen in FIG. 1, authentication system 10 additionally includes an authentication device 28 and a hardware controller 30. Hardware controller 30 includes a module 32 that generates or creates a challenge 34 prior or subsequent to connection or coupling 22 of accessory 24 to port 20, as generally indicated by arrow 36. Challenge 34 is then sent or transmitted to authentication device 28, as generally indicated by arrow 38. Authentication device 28 creates or generates an accessory response 40 upon receipt of challenge 34 from hardware controller 30 and returns or transmits accessory response 40 back to hardware controller 30, as generally indicated by arrow 42.

As can further be seen in FIG. 1, hardware controller 30 also generates or creates an expected response 44 to challenge 34. Upon receipt of accessory response 40, hardware controller 30 compares expected response 44 to accessory response 40 to ascertain if accessory response 40 is valid or invalid. If accessory response 40 is valid, then accessory 24 is deemed to be authentic and hardware controller 30 signals for port 20 to be enabled so that computing device 12 may access functionality on accessory 24. This is illustrated by arrow 46 in FIG. 1 from expected response module 48 of hardware controller 30 to connection 22 of port 20 which closes switch 26. Once switch 26 is closed, a connection is established between processor 14 of computing device 12 and accessory 24, as generally indicated by respective arrows 50 and 52. Hardware controller 30 may signal that an authorized accessory 24 is connected to computing device 12, as generally indicated by dashed arrow 54. A message indicating this may, in turn, be displayed to a user of computing device 12.

If hardware controller 30 determines that accessory response 40 is invalid, then accessory 24 is deemed to be non-authentic and port 20 remains disabled, prohibiting access to accessory 24 by computing device 12. Hardware controller 30 may signal that an unauthorized accessory is connected to computing device 12, as generally indicated by dashed arrow 54. A message indicating this may, in turn, be displayed to a user of computing device 12.

Hardware controller 30 may use firmware rather than software to help secure computing device 12 from use of unauthorized accessories. Such use of firmware helps to prevent reverse engineering or “hacking” of hardware controller 30 in an attempt to use unauthorized accessories with computing device 12.

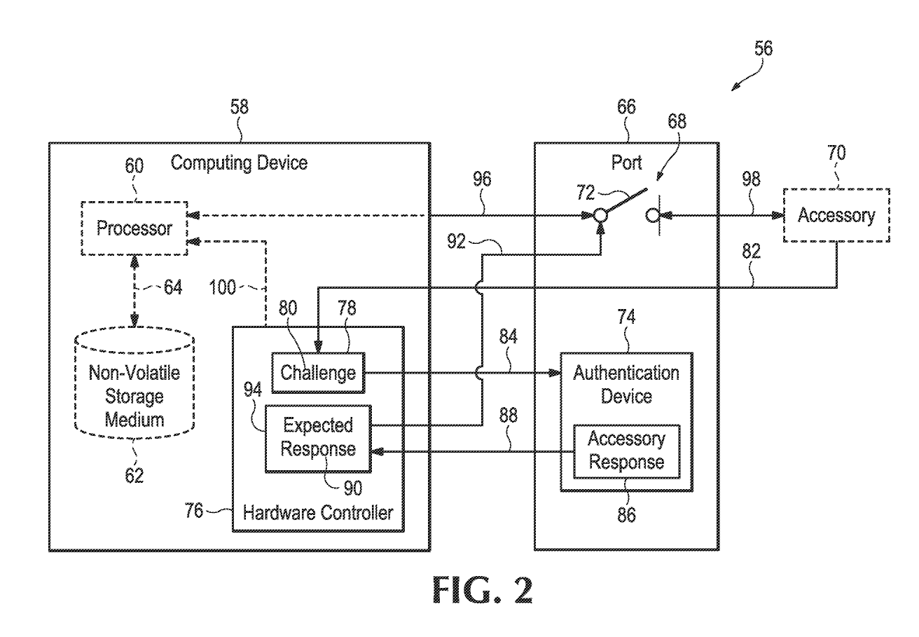

Another example of an authentication system 56 is shown in FIG. 2. Authentication system 56 includes a computing device 58 that may include a processor 60 and a non-volatile storage medium 62 that includes instructions executable by processor 60, as generally indicated by dashed double-headed arrow 64. Processor 60 may also store data on non-volatile storage medium 62, as also generally indicated by dashed doubled-headed arrow 64. Although not shown in FIG. 2, it is to be understood that computing device 58 may include other components and elements such as a keyboard, display, video card, etc.

As can also be seen in FIG. 2, authentication system 56 also includes a port 66 associated with computing device 58 for connection or coupling 68 of an accessory 70 to computing device 58. This coupling or connection 68 may be established in any of variety of ways depending upon the particular characteristics of port 66 and/or accessory 70. For sake of discussion purposes, it is illustrated as a switch 72 that is normally open prior to any verification of the integrity and source of accessory 70 by authentication system 56, as discussed more fully below.

As can additionally be seen in FIG. 2, authentication system 56 additionally includes an authentication device 74 embedded in and part of port 66 and a hardware controller 76 embedded in computing device 58. Hardware controller 76 includes a module 78 that generates or creates a challenge 80 prior or subsequent to connection or coupling 68 of accessory 70 to port 66, as generally indicated by arrow 82. Challenge 80 is then sent or transmitted to authentication device 74, as generally indicated by arrow 84. Authentication device 74 creates or generates an accessory response 86 upon receipt of challenge 80 from hardware controller 76 and returns or transmits accessory response 86 back to hardware controller 76, as generally indicated by arrow 88.

As can further be seen in FIG. 2, hardware controller 76 also generates or creates an expected response 90 to challenge 80. Upon receipt of accessory response 86, hardware controller 76 compares expected response 90 to accessory response 86 to ascertain if accessory response 86 is valid or invalid. If accessory response 86 is valid, then accessory 70 is deemed to be authentic and hardware controller 76 signals for port 66 to be enabled so that computing device 58 may access functionality on accessory 70. This is illustrated by arrow 92 in FIG. 2 from expected response module 94 of hardware controller 76 to connection 68 of port. 66 which closes switch 72. Once switch 72 is closed, a connection is established between processor 60 of computing device 58 and accessory 70, as generally indicated by respective arrows 96 and 98. Hardware controller 76 may signal that an authorized accessory 70 is connected to computing device 58, as generally indicated by dashed arrow 100. A message indicating this may, in turn, be displayed to a user of computing device 58.

If hardware controller 76 determines that accessory response 86 is invalid, then accessory 70 is deemed to be non-authentic and port 66 remains disabled, prohibiting access to accessory 70 by computing device 58. Hardware controller 76 may signal that an unauthorized accessory is connected to computing device 58, as generally indicated by dashed arrow 100. A message indicating this may, in turn, be displayed to a user of computing device 58.

Hardware controller 76 may use firmware rather than software to help secure computing device 58 from use of unauthorized accessories. Such use of firmware helps to prevent reverse engineering or “hacking” of hardware controller 76 in an attempt to use unauthorized accessories with computing device 58.

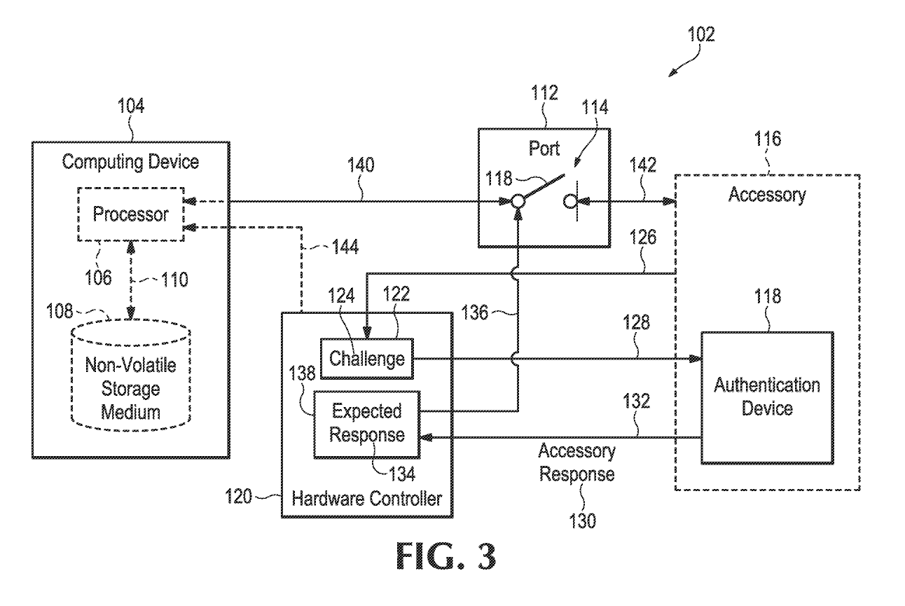

An additional example of an authentication system 102 is shown in FIG. 3. Authentication system 102 includes a computing device 104 that may include a processor 106 and a non-volatile storage medium 108 that includes instructions executable by processor 106, as generally indicated by dashed double-headed arrow 110. Processor 106 may also store data on non-volatile storage medium 108, as also generally indicated by dashed doubled-headed arrow 110. Although not shown in FIG. 3, it is to be understood that computing device 104 may include other components and elements such as a keyboard, display, video card, etc.

As can also be seen in FIG. 3, authentication system 102 also includes a port 112 associated with computing device 104 for connection or coupling 114 of an accessory 116 to computing device 104. This coupling or connection 114 may be established in any of variety of ways depending upon the particular characteristics of port 112 and/or accessory 116. For sake of discussion purposes, it is illustrated as a switch 118 that is normally open prior to any verification of the integrity and source of accessory 116 by authentication system 102, as discussed more fully below.

As can additionally be seen in FIG. 3, authentication system 102 additionally includes an authentication device 118 embedded in and part of accessory 116 and a hardware controller 120. Hardware controller 120 includes a module 122 that generates or creates a challenge 124 prior or subsequent to connection or coupling 114 of accessory 116 to port 112, as generally indicated by arrow 126. Challenge 124 is then sent or transmitted to authentication device 118, as generally indicated by arrow 128. Authentication device 118 creates or generates an accessory response 130 upon receipt of challenge 124 from hardware controller 120 and returns or transmits accessory response 130 back to hardware controller 120, as generally indicated by arrow 132.

As can further be seen in FIG. 3, hardware controller 120 also generates or creates an expected response 134 to challenge 124. Upon receipt of accessory response 130, hardware controller 120 compares expected response 134 to accessory response 130 to ascertain if accessory response 130 is valid or invalid. If accessory response 130 is valid, then accessory 116 is deemed to be authentic and hardware controller 120 signals for port 112 to be enabled so that computing device 104 may access functionality on accessory 116. This is illustrated by arrow 136 in FIG. 3 from expected response module 138 of hardware controller 120 to connection 114 of port 112 which closes switch 118. Once switch 118 is closed, a connection is established between processor 106 of computing device 104 and accessory 116, as generally indicated by respective arrows 140 and 142. Hardware controller 120 may signal that an authorized accessory 116 is connected to computing device 104, as generally indicated by dashed arrow 144. A message indicating this may, in turn, be displayed to a user of computing device 104.

If hardware controller 120 determines that accessory response 130 is invalid, then accessory 116 is deemed to be non-authentic and port 112 remains disabled prohibiting access to accessory 116 by computing device 104. Hardware controller 120 may signal that an unauthorized accessory is connected to computing device 104, as generally indicated by dashed arrow 144. A message indicating this may, in turn, be displayed to a user of computing device 104.

Hardware controller 120 may use firmware rather than software to help secure computing device 104 from use of unauthorized accessories. Such use of firmware helps to prevent reverse engineering or “hacking” of hardware controller 120 in an attempt to use unauthorized accessories with computing device 104.

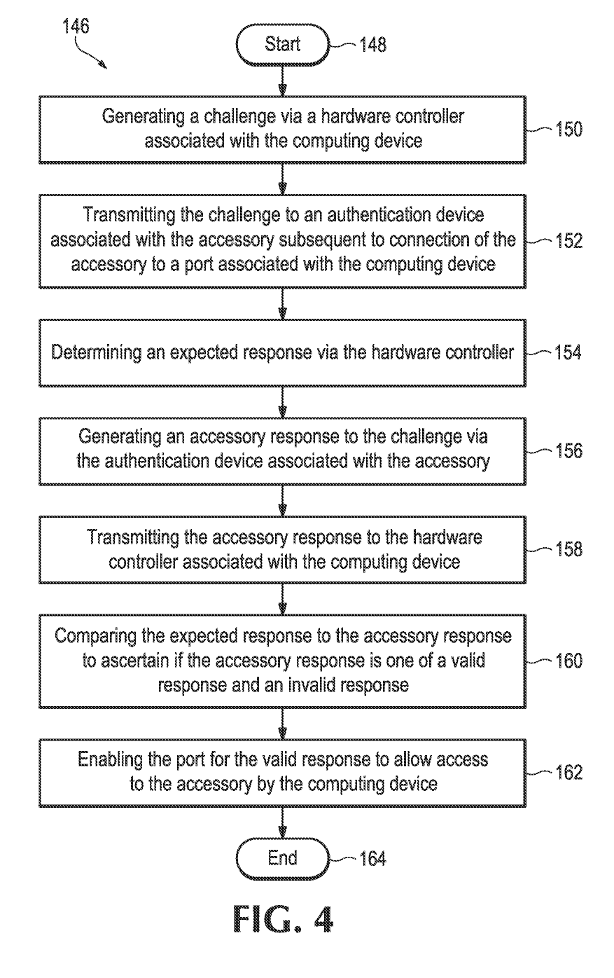

An example of a method of authenticating an accessory 146 for use by a computing device is shown in FIG. 4. Method 146 starts 148 by generating a challenge via a hardware controller associated with the computing device, as indicated by block 150, and transmitting the challenge to an authentication device associated with the accessory subsequent to connection of the accessory to a port associated with the computing device, as indicated by block 152. Next, method 146 continues by determining an expected response via the hardware controller, as indicated by block 154, and generating an accessory response to the challenge via the authentication device associated with the accessory, as indicated by block 156. Method 146 continues by transmitting the accessory response to the hardware controller associated with the computing device, as indicated by block 158, and comparing the expected response to the accessory response to ascertain if the accessory response is a valid response or an invalid response, as indicated by block 160. Method 146 further continues by enabling the port for the valid response to allow access to the accessory by the computing device, as indicated by block 162. Method 146 may then end 164.

In the example of method 146, the port may remain disabled for the invalid response to prohibit access to the accessory by the computing device. Also, the challenge and/or the accessory response may be transmitted via the port. Additionally, the computing device may include the hardware controller, and either the accessory or the port may include the authentication device. Furthermore, the hardware controller may utilize firmware rather than software to generate the challenge to help secure the computing device from using unauthorized accessories.

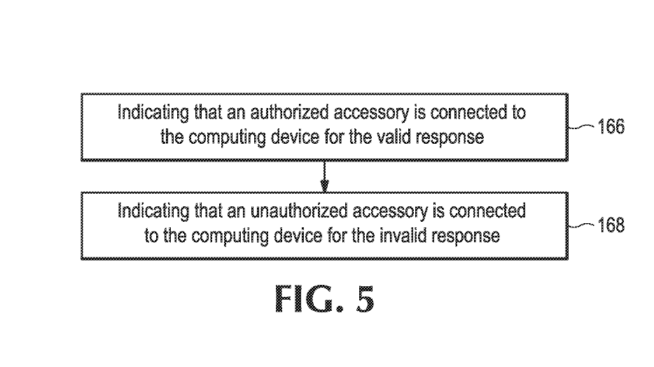

An example of one or more further possible elements of the method of authenticating an accessory 146 is illustrated in FIG. 5. As can be seen in FIG. 5, method 146 may include indicating that an authorized accessory is connected to the computing device for the valid response, as indicated by block 166. Alternatively or additionally, method 146 may include indicating that an unauthorized accessory is connected to the computing device for the invalid response, as indicated by block 168.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. For example, one or more of ports 20, 66, and 112 may be integrally formed in respective computing devices 12, 58, and 104. As another example, a hardware controller may be embedded in a port. As a further example, a hardware controller may signal for a port to be enabled via a processor instead of directly enabling the port. The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. An authentication system, comprising:
a computing device;
a port associated with the computing device for connection of an accessory to the computing device;
an authentication device that generates an accessory response upon receipt of a challenge; and
a hardware controller that generates both the challenge and an expected response to the challenge, that compares the expected response to the accessory response to ascertain if the accessory response is one of a valid response and an invalid response, and that signals for the port to be enabled for the valid response to allow access to functionality of the accessory by the computing device.

2. The authentication system of claim 1, wherein the port remains disabled for the invalid response to prohibit access to the accessory by the computing device.

3. The authentication system of claim 1, wherein the hardware controller signals that an authorized accessory is connected to the computing device for the valid response.

4. The authentication system of claim 1, wherein the hardware controller signals that an unauthorized accessory is connected to the computing device for the invalid response.

5. The authentication system of claim 1, wherein the hardware controller is embedded in the computing device.

6. The authentication system of claim 1, wherein the authentication device is embedded in one of the accessory and the port.

7. The authentication system of claim 1, wherein one of the challenge and the accessory response are transmitted via the port.

8. The authentication system of claim 1, wherein the hardware controller utilizes firmware rather than software to help secure the computing device from use of unauthorized accessories.

9. A method of authenticating an accessory for use by a computing device, comprising:
generating a challenge via a hardware controller associated with the computing device;
transmitting the challenge to an authentication device associated with the accessory subsequent to connection of the accessory to a port associated with the computing device;
determining an expected response via the hardware controller;
generating an accessory response to the challenge via the authentication device associated with the accessory;
transmitting the accessory response to the hardware controller associated with the computing device;
comparing the expected response to the accessory response to ascertain if the accessory response is one of a valid response and an invalid response; and
enabling the port for the valid response to allow access to the accessory by the computing device.

10. The method of claim 9, wherein the port remains disabled for the invalid response to prohibit access to the accessory by the computing device.

11. The method of claim 9, further comprising indicating that an authorized accessory is connected to the computing device for the valid response.

12. The method of claim 9, further comprising indicating that an unauthorized accessory is connected to the computing device for the invalid response.

13. The method of claim 9, wherein one of the challenge and the accessory response is transmitted via the port.

14. The method of claim 9, wherein one of the computing device includes the hardware controller, the accessory includes the authentication device, and the port includes the authentication device.

15. The method of claim 9, wherein the hardware controller utilizes firmware rather than software to generate the challenge to help secure the computing device from using unauthorized accessories.
